(19) United States
(12) Patent Application Publication
(10) Pub. No.: US 2018/0228572 A1
(43) Pub. Date: Aug. 16, 2018

(54) DENTAL HANDPIECE WITH REAR AIR EXHAUST

(71) Applicant: Pac-Dent International, Inc., Brea, CA (US)

(72) Inventors: Joseph Fernandez, Las Vegas, NV (US); Alfred Perez, Las Vegas, NV (US); Daniel Wang, Brea, CA (US); Bo Tao, Chino, CA (US); Xiao Yang, La Habra, CA (US)

(73) Assignee: Pac-Dent International, Inc., Brea, CA (US)

(21) Appl. No.: 15/892,263

(22) Filed: Feb. 8, 2018

Related U.S. Application Data
(60) Provisional application No. 62/458,425, filed on Feb. 13, 2017.

(51) Int. Cl. A61C 1/05; A61C 17/02; A61C 3/02

(52) U.S. Cl. CPC A61C 1/052; A61C 3/02; A61C 17/0202

(57) ABSTRACT

The present invention provides an air driven dental handpiece device with a back end configured to receive an air and water supply; a handpiece body having an air intake tube and a water line tube carrying air and water respectively through the device; and a head receiving air to power the device's dental spindle. The head securely blocks air from leaking and returns the air through a large air return exhaust port back through the inside of the body and out a rear air exhaust assembly including a plurality of exhaust air holes and/or an air return exhaust port. The device helps eliminate a patient's sensitivity and discomfort, helps eliminate the risk of surgical air emphysema, as well as helps eliminate any cross contamination during oral surgical procedures.

### CROSS REFERENCE TO RELATED APPLICATIONS

This application claims priority under 35 U.S.C. § 119(e) to U.S. Provisional Application No. 62/458,425, filed Feb. 13, 2017, and entitled “Dental Handpiece with Rear Air Exhaust,” the disclosure of which is hereby incorporated by reference in its entirety.

### BACKGROUND OF THE INVENTION

### 1. Field of Invention

The invention relates generally to dentistry systems and devices, and more specifically, to an improved air driven dental handpiece.

### 2. Description of Related Art

A dental handpiece is a dentistry tool, typically used for removing tooth decay and changing a tooth's structure prior to the insertion of a dental filling or crown to restore the integrity of a tooth's structure and prior cleaning a root canal.

A dental handpiece is often colloquially referred to, and better known as, a dental drill, although sometimes a dental drill refers to additional components powering or surrounding the dental drill such as a dental engine.

A dental engine is located nearby a dentist and a patient, and is a large appliance that typically includes a small table to hold an instrument tray, a light, a computer display, a small faucet, and mouth rinsing sink. Additionally, a dental engine delivers power to the dentist's hand tools such as the drill, an ultrasonic cleaning apparatus, or an air and water dental syringe device.

An air and water dental syringe device supplies water, air, or mist to the patient's mouth to clean away debris from an area that the dentist is working on. Conventional air and water dental syringe devices are handheld and deliver air and water under pressure. These devices contain valves and buttons on the body of the device that allow for selective discharge of water or air. These devices are widely used by dentists, orthodontists, oral surgeons, dental assistants, and dental hygienists and similar personnel.

### SUMMARY OF THE INVENTION

The present invention provides an air driven dental handpiece device with a back end configured to receive an air and water supply; a handpiece body having an air intake tube and a water line tube carrying air and water respectively through the device; and a head receiving air to power the device's dental spindle. The head securely blocks air from leaking and returns the air through a large air return exhaust port back through the inside of the body and out a rear air exhaust assembly including a plurality of exhaust air holes and/or a rear air exhaust port. The device helps eliminate a patient's sensitivity and discomfort, helps eliminate the risk of surgical air emphysema, as well as helps eliminate any cross contamination during oral surgical procedures.

In one embodiment, an air driven dental handpiece device comprises: a back end at a proximal end, the back end comprising an exterior port of air, an exterior port of water, and a rear air exhaust assembly, the exterior port of air configured to receive air from an air supply, the exterior port of water configured to receive water from a water supply, and the rear air exhaust assembly to expel the air out the back end, the rear air exhaust assembly comprising at least one of a plurality of exhaust air holes or a rear air exhaust port; a handpiece body connected to the back end, the body comprising an air intake tube and a water line tube, the air intake tube connecting to the exterior port of air, the water line tube connecting to the exterior port of water, the water line tube flowing the water, and the air intake tube flowing the air through the body; and a head at a distal end, the head comprising an air intake port, and an air return exhaust port, the air intake port driving a dental spindle using the air, and the air return exhaust port returning the air back through the body and to the rear air exhaust assembly.

In another embodiment, a system comprises: an air supply; a water supply; a back end at a proximal end, the back end comprising an exterior port of air, an exterior port of water, and a rear air exhaust assembly, the exterior port of air configured to receive air from the air supply, the exterior port of water configured to receive water from the water supply, and the rear air exhaust assembly to expel the air out the back end, the rear air exhaust assembly comprising at least one of a plurality of exhaust air holes or a rear air exhaust port; a handpiece body connected to the back end, the body comprising an air intake tube and a water line tube, the air intake tube connecting to the exterior port of air, the water line tube connecting to the exterior port of water, the water line tube flowing the water, and the air intake tube flowing the air through the body; and a head at a distal end, the head comprising an air intake port, and an air return exhaust port, the air intake port driving a dental spindle using the air, and the air return exhaust port returning the air back through the body and to the rear air exhaust assembly.

In a further embodiment, a method comprises the steps of: receiving an air supply and a water supply in a back end at a proximal end of an air driven dental handpiece device, the back end comprising an exterior port of air, an exterior port of water, and a rear air exhaust assembly, the exterior port of air configured to receive air from the air supply, the exterior port of water configured to receive water from the water supply, and the rear air exhaust assembly to expel the air out the back end, the rear air exhaust assembly comprising at least one of a plurality of exhaust air holes or a rear air exhaust port; flowing the water through a water line tube in a body and flowing the air through an air intake tube in the body, the air intake tube connecting to the exterior port of air, the water line tube connecting to the exterior port of water; powering a dental spindle using the air received at a head, the head at a distal end, the head comprising an air intake port, and an air return exhaust port, the air intake port driving the dental spindle using the air, and the air return exhaust port returning the air back through the body and to the rear air exhaust assembly; blocking air leakage from the head; and expelling the air out the back end of the device using the rear air exhaust assembly.

An advantage of the present invention is the device provides an air sealed environment in the head portion. The air sealed environment forms an air free device, where the device prevents all air leakage from the head portion, instead leading the air to exhaust through the rear portion of the handpiece. The air free environment helps to eliminate patients' sensitivity and discomfort, the risk of surgical air emphysema, as well as any cross contamination during oral surgical procedures. The air-free device provides improvements in orthodontics, oral surgery, periodontics, and general dentistry.

Specifically, in orthodontics, the air-free device eliminates air sensitivity and patient discomfort during removal of bonding adhesive (e.g., Invisalign attachments), where orthodontics is an area of dentistry concerned with the treatment of improper bites and crooked teeth, and uses devices such as braces and clear aligners to align the patient's teeth. In oral surgery, also referred to more broadly as dental surgery, the air-free device prevents air from entering the oral cavity during surgical extractions and vertical impactions, where a surgical extraction is used to remove a broken tooth if the tooth broke off at the gum line and an example of a vertical impaction would be an impacted wisdom tooth with no tilt. In periodontics, a branch of dentistry concerned with the structures surrounding and supporting the teeth, the air free device eliminates the risk of surgical emphysema with this air free high-speed device. There is no need to use an expensive high-speed electric device. In general dentistry, this device is ideal for patients with gingivitis, an inflammation of the gums, and ideal for other forms of hypersensitivity, where general dentistry includes the diagnosis, prevention, and treatment of the oral cavity, primarily the teeth, through dental treatments that as fillings, crowns, bridges, dentures tooth extraction, x-rays, etc., the air free high-speed device reduces sensitivity and discomfort for patients.

Conventional high speeds exhaust air through the head region, either through the front end of the head which pass air into the patient's mouth, the back end of the head, sometimes referred to as a cap, or out the head internally through an exhaust line. Unlike conventional dental drills, in this air free handpiece there is no air escaping from the head region, the air free high speed device exits air out a rear air exhaust assembly. All of the air is redirected through the shell of the body and expelled through external ports that are located right above the threads, where the threads are circular threads allowing the bottom of the dental handpiece to be rotatably attached to a dental engine or air/water supply.

The present invention provides an air driven dental handpiece device with a back end configured to receive an air and water supply; a handpiece body having an air intake tube and a water line tube carrying air and water respectively through the device; and a head receiving air to power the device's dental spindle. The head securely blocks air from leaking and returns the air through a large air return exhaust port back through the inside of the body and out a rear air exhaust assembly including a plurality of exhaust air holes and/or a rear air exhaust port. The device helps eliminate patients' sensitivity and discomfort, helps eliminate the risk of surgical air emphysema, as well as helps eliminate any cross contamination during oral surgical procedures.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a perspective view of an air and water driven dental system according to an embodiment of the invention;

FIG. 2 illustrates a cross section view of a high speed air driven dental handpiece device for the system according to an embodiment of the invention;

FIG. 3 illustrates a rotated cross section view of the device according to an embodiment of the invention;

FIG. 4 illustrates a perspective view of a head of the device according to an embodiment of the invention;

FIG. 5 illustrates a cross section view of the head of the device according to an embodiment of the invention; and

FIG. 6 illustrates a dental handpiece rear air exhaust process according to an embodiment of the invention.

### DETAILED DESCRIPTION OF EMBODIMENTS

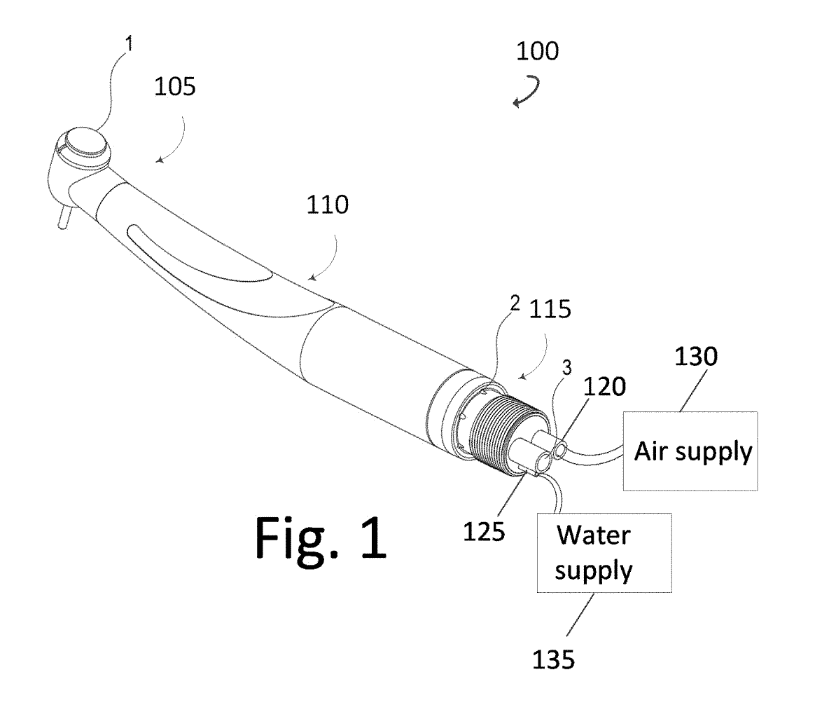

Further features and advantages of the invention, as well as the structure and operation of various embodiments of the invention, are described in detail below with reference to the accompanying FIGS. 1-6, wherein like reference numerals refer to like elements. Although a handpiece is illustrated with a particular number of ports or holes to exhaust air, one with skill in the art could include more or less holes without departing from the spirit of the invention. Also, although handpiece is illustrated with a rear exhaust assembly in the very back of the handpiece, one of skill in the art could place that further up the body without the high pressure air affecting the patient.

In embodiments of the present invention, a high speed air-driven dental handpiece is provided with a rear air exhaust mechanism to eliminate air sensitivity, patient discomfort, risk of surgical emphysema and contamination during oral surgery operations. The head portion of the handpiece comprises a large air return exhaust port, an air-driven turbine, a port of water, and a plurality of seals. The elongated handpiece body comprises an air intake tube connected to an air supply to drive the turbine, a water line tube connected to the port of water in the head portion on one end, and to an exterior port of water for supplying water to near the head portion on the other end, a drive rear air exhaust port on the back end of the handpiece body for exhausting the air after driving the turbine, and multiple exhaust air holes on the back end of the body.

FIG. 1 illustrates a perspective view of an air and water driven dental system 100 according to an embodiment of the invention. The system 100 includes a device with a head 105 including a pressure sealed back cap 1, handpiece body 110, and a back end 115 including a plurality of exhaust air holes 2, a rear air exhaust port 3, an exterior port of air 120, and an exterior port of water 125. The system 100 also includes an air supply 130 and a water supply 135.

The system 100 is generally a small, high-speed dentist drill used during dental procedures, usually to remove decay and shape tooth structure prior to the insertion of a filling or crown. The system 100 may also be used in the cleaning and shaping of root canals during endodontic treatment, to remove old or temporary fillings or crowns prior to the insertion of new or permanent restorations, or to remove bonding adhesives or other attachments. An exemplary attachment is a clear aligner, an orthodontic device that uses incremental transparent aligners to adjust teeth as an alternative to dental braces, such as an Invisalign attachment.

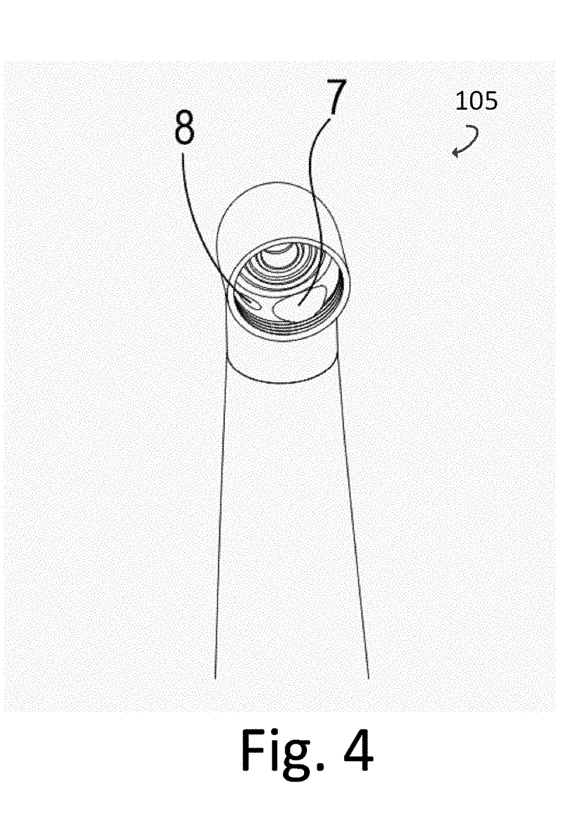

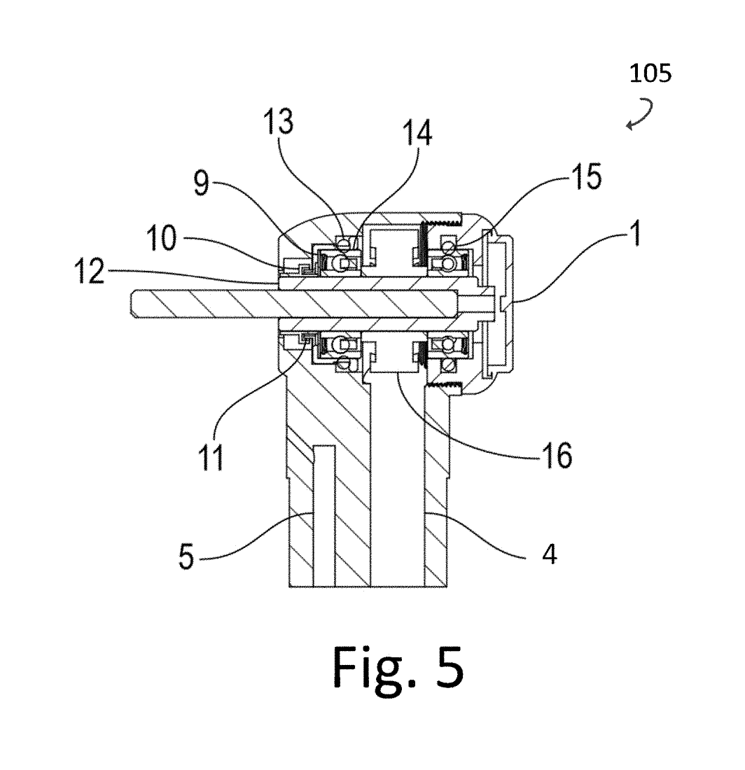

The head 105 is at a distal end of the device. The head 105 is air powered and drives the drill. The head is pressure sealed and securely blocks air from leaking from the head 105. The head 105 is discussed further with respect to FIGS. 4-5. The pressure sealed back cap 1 on the head 105 prevents any air leakage from the back of the head 105, the cap 1 working with all the other sealing mechanisms discussed in FIG. 5 to further prevent air leakage during a dental operation.

The handpiece body 110 connects the head 105 to the back end/rear end 115. The handpiece body 110 contains tubes within to transfer both air and water from the back end 115 to the head 105. The handpiece body 110 also contains non-tube space inside for air to travel back towards the back end 115 to expel air out of the device.

The back end 115 is at the proximal end of the device. The back end 115 is the point of entry for high powered air through the exterior port of air 120 from the air supply 130 and entry for water through the exterior port of water 125 from the water supply 135. The back end 115 is also the point of exit for air after powering the device, through the plurality of exhaust air holes 2 and the rear air exhaust port 3. The exhaust air holes 2 include multiple air holes on the rear end 115 of the handpiece to export air. The plurality of exhaust air holes 2 are located on or near the back end 115 of the body 110, or at least away from the patient (i.e., the front of the head 105), exhausting the air from inside the handpiece body 110 after driving the device's spindle. The rear air exhaust port 3, also referred to as a drive air exhaust port, works in a similar fashion to the exhaust air holes 2. The rear air exhaust port 3 is located on or near the back end 115, or at least away from the patient, is configured to exhaust the air from inside the handpiece body 115 after being used to drive the turbine.

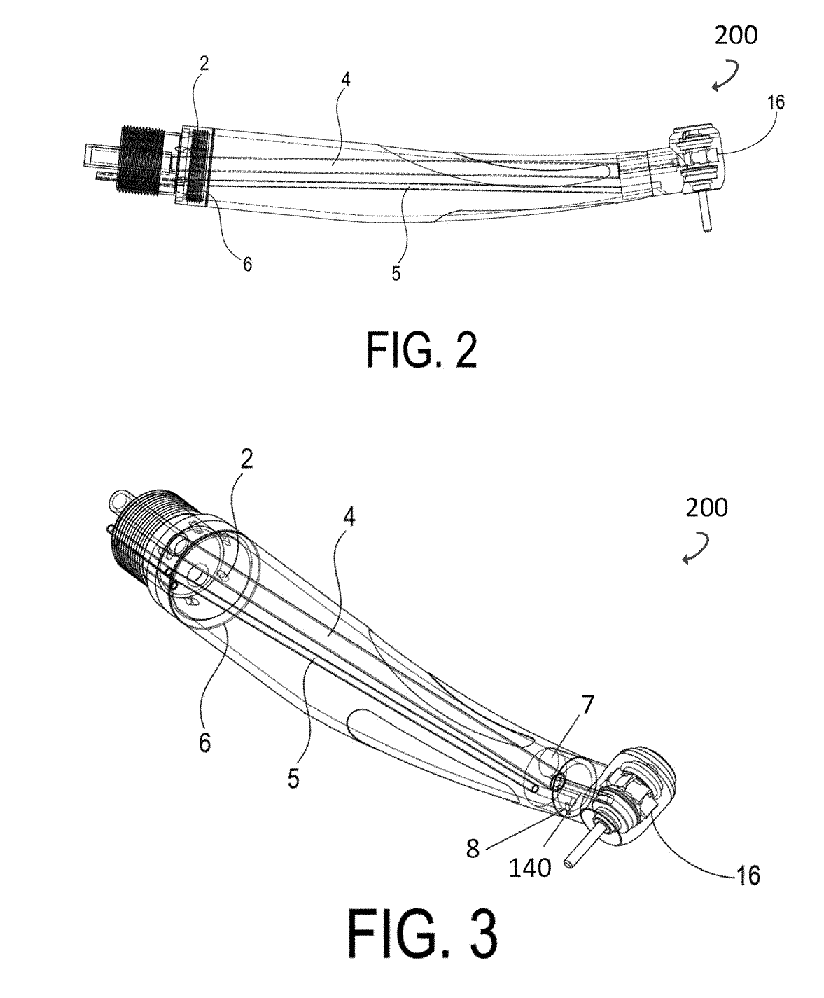

FIG. 2 illustrates a cross section view of a high speed air driven dental handpiece device 200 for the system 100 according to an embodiment of the invention. This view of the device 200 (e.g., an air-free device, air driven dental handpiece device, etc.) illustrates the plurality of exhaust air holes 2, an air intake tube 4, a water line tube 5, a rear air exhaust assembly 6, and an air driven turbine 16.

The air intake tube 4 receives air from the back end 115 and passes the air through the handpiece body 110 to the head 105. The air intake tube 4 connects the exterior port of air 120 to the head 105 and powers the turbine 16 powering the device 200.

Similarly, the water line tube 5 receives water from the back end 115 and passes water through the handpiece body 110. The water line tube 5 is connected to the exterior port of water 125 to provide liquid near but not within the head portion 105 when needed by the dentist.

While the tubes within the body 110 are an intake air tube 4 and an intake water tube 5, the air travels back through the handpiece body 110 not through the tubes 4, 5, but through the non-tube space towards the back end 115 to expel air out of the device. The dotted lines in FIG. 2 illustrated near the edges of the body 110 are contours of the circular handpiece, and are not return paths or tubes for the air.

The rear air exhaust assembly 6 includes the plurality of exhaust air holes 2 and the air return exhaust port 3 to export, that is, expel air from the rear end 115 of the handpiece 200, or at least away from the patient (i.e., the front of the head 105). However, it is important that the air exit the rear end and not out the cap 1 or somewhere else near the head 105, because during the operation process, the head portion of the device 200 will be inside a patient's mouth and if the air exhaust towards the cavity or gum of the patient, it may cause sensitivity and discomfort. In this way, the handpiece 200 helps eliminate a patient's sensitivity and discomfort, helps eliminate the risk of surgical air emphysema, as well as helps eliminate any cross contamination during oral surgical procedures.

The air driven turbine 16, also referred to as an impeller or simply a turbine, is powered by the high powered air passed through the handpiece body 110. The turbine 16 is rotatably spun by the air coming from the air intake tube 4, then the turbine 16 rotates the dental drill (that is, spindle).

FIG. 3 illustrates a rotated cross section view of the device 200 according to an embodiment of the invention. The device 200 is illustrated at another angle showing the plurality of exhaust air holes 2, the air intake tube 4, the water line tube 5, the rear air exhaust assembly 6, the air driven turbine 16, an air intake port 8, an air return exhaust port 7, and an interior port of water 140.

High speed air to the turbine 16 powers the device 200. The air enters the head 105 through air intake port 8, and after powering the device 200, the air exits through return exhaust port 7 (e.g., large air return exhaust port) returns the air through the body 110 and then out through the exhaust air holes 2 and/or the drive air return exhaust port 3.

The interior port of water 140 outputs water out of the handpiece 200 when needed during an operation. The water line 5 has its own separate port to where the water is expelled from, and the water does not enter the head cavity 105.

FIG. 4 illustrates a perspective view of the head 105 of the device 200 according to an embodiment of the invention. This view of the head 105 illustrates the air intake port 8 and the air return exhaust port 7. After the air intake tube 4 powers the device's turbine 16 through the air intake port 8, then the air flows back through the air return exhaust port 7 and the handpiece body 110 to the rear end 115 of the handpiece, or at least away from the patient.

FIG. 5 illustrates a cross section view of the head 105 of the device 200 according to an embodiment of the invention. The head 105 in this view illustrates the pressure sealed back cap 1, the air intake tube 4, the water line tube 5, an air-block washer 9, a slinger 10, a bearing cup 11, a spindle 12, a front O-ring 13, a front bearing 14, and a rear O-ring 15. The head 105 illustrates similar or the same components on both sides of the spindle 12, meaning the head 105 illustrates a pair of air-block washers 9, slingers 10, bearing cups 11, front O-rings 13, front bearings 14, and a rear O-rings 15.

The air-block washer 9, located in the head portion and seated on the inner surface of the bearing cup 11, securely blocks air leakage from the head portion of the handpiece and seals the head portion. The slinger 10 in the head portion 105 assists the turbine 16 in reversing the air flow and the slinger 10, further blocks air leakage from the head portion 105, and further seals the head portion 105.

The bearing cup 11 provides structure to assemble the washer and several seal mechanism inside the head portion 105. The spindle 12 (e.g., drill, dental spindle, etc.) is seated in the head portion of the handpiece, can be connected with several kinds of burs to satisfy the need of operation, where the extending needle represents a bur.

The front bearing 14, a second bearing feature, works in concert with bearing cup 11, as bearing 14 is provides the needed structure for the head portion 105. The front O-ring 13 and the rear O-ring 15, also referred to as a plurality of seals, both form sealing assemblies to prevent leakage of the air and further seal the head 105.

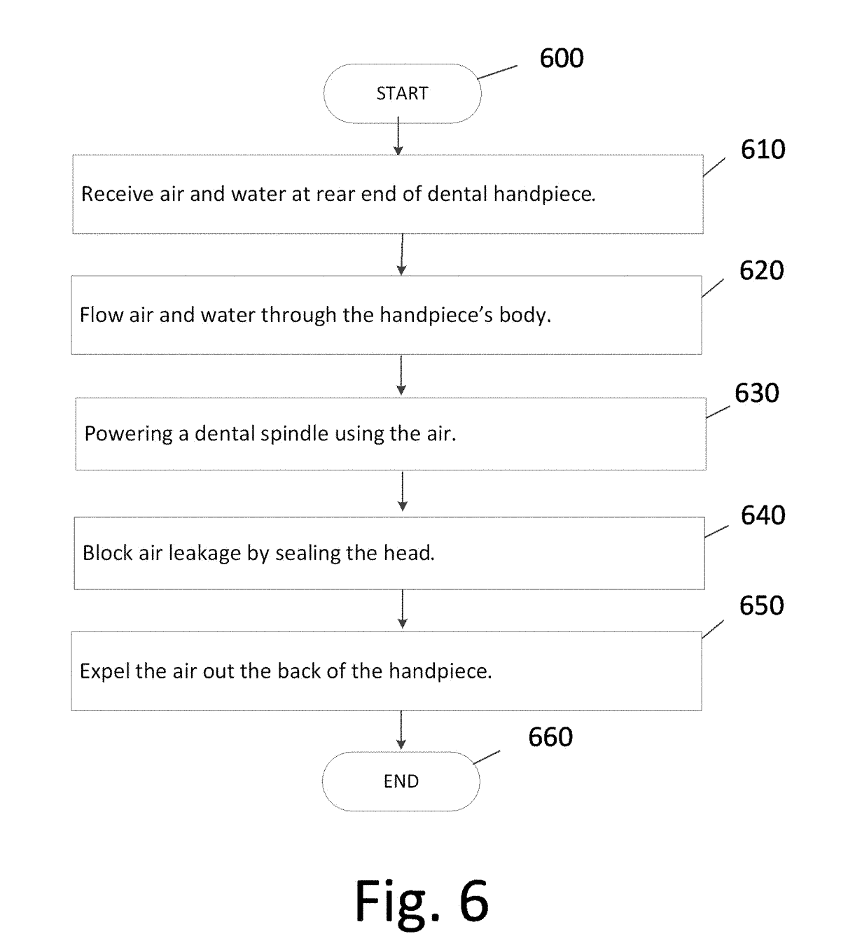

FIG. 6 illustrates a dental handpiece rear air exhaust process according to an embodiment of the invention. The process starts at step 600. At step 610, a high speed air driven dental handpiece device 200 receives air and water at a back end 115. At step 620, the air intake tube 4 and water line tube 5 flow air and water respectively through the handpiece body 110. At step 630, the air powers the dental spindle 12. At step 640, the air-block washer 9, the slinger 10, and the front and rear O-rings 14, 15 block air leakage by sealing the head 105. At step 650, the air exhaust assembly 6, including the plurality of exhaust air holes 2 and/or the rear air exhaust port 3, expel the air out the back of the handpiece device 200. The process ends at step 660.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. An air driven dental handpiece device comprising:
a back end at a proximal end, the back end comprising an exterior port of air, an exterior port of water, and a rear air exhaust assembly, the exterior port of air configured to receive air from an air supply, the exterior port of water configured to receive water from a water supply, and the rear air exhaust assembly to expel the air out the back end, the rear air exhaust assembly comprising at least one of a plurality of exhaust air holes or a rear air exhaust port;
a handpiece body connected to the back end, the body comprising an air intake tube and a water line tube, the air intake tube connecting to the exterior port of air, the water line tube connecting to the exterior port of water, the water line tube flowing the water, and the air intake tube flowing the air through the body; and
a head at a distal end, the head comprising an air intake port, the air intake port driving a dental spindle using the air, and the air return exhaust port returning the air back through the body and to the rear air exhaust assembly.

2. The device of claim 1, wherein the rear air exhaust port of the rear air exhaust assembly exhausts the air from the body after the air powers a turbine that drives the dental spindle.

3. The device of claim 1, wherein the plurality of exhaust air holes of the rear air exhaust assembly exhaust the air from the body after the air powers a turbine that drives the dental spindle.

4. The device of claim 1, wherein the rear air exhaust assembly receives the air after the air drives the dental spindle and the rear air exhaust assembly expels the air out of the device.

5. The device of claim 1, wherein the head further comprises a slinger to block air leakage from the head and to reverse air flow.

6. The device of claim 1, wherein the head further comprises a pressure sealed back cap to block air leakage from the head.

7. The device of claim 1, wherein the head further comprises an air-block washer to block air leakage from the head.

8. The device of claim 7, wherein the air-block washer is seated on an inner surface of a bearing cup.

9. The device of claim 1, wherein the head further comprises a plurality of seals to block air leakage from the head.

10. The device of claim 9, wherein the plurality of seals comprises a front O-ring and a rear O-ring.

11. The device of claim 1, wherein the device is a dental drill.

12. A system comprising:
an air supply;
a water supply;
a back end at a proximal end, the back end comprising an exterior port of air, an exterior port of water, and a rear air exhaust assembly, the exterior port of air configured to receive air from the air supply, the exterior port of water configured to receive water from the water supply, and the rear air exhaust assembly to expel the air out the back end, the rear air exhaust assembly comprising at least one of a plurality of exhaust air holes or a rear air exhaust port;
a handpiece body connected to the back end, the body comprising an air intake tube and a water line tube, the air intake tube connecting to the exterior port of air, the water line tube connecting to the exterior port of water, the water line tube flowing the water, and the air intake tube flowing the air through the body; and
a head at a distal end, the head comprising an air intake port, the air intake port driving a dental spindle using the air, and the air return exhaust port returning the air back through the body and to the rear air exhaust assembly.

13. The system of claim 12, wherein the rear air exhaust port of the rear air exhaust assembly exhausts the air from the body after the air powers a turbine that drives the dental spindle.

14. The system of claim 12, wherein the plurality of exhaust air holes of the rear air exhaust assembly exhaust the air from the body after the air powers a turbine that drives the dental spindle.

15. The system of claim 12, wherein the head further comprises a plurality of seals to block air leakage from the head.

16. A method comprising:
receiving an air supply and a water supply in a back end at a proximal end of an air driven dental handpiece device, the back end comprising an exterior port of air, an exterior port of water, and a rear air exhaust assembly, the exterior port of air configured to receive air from the air supply, the exterior port of water configured to receive water from the water supply, and the rear air exhaust assembly to expel the air out the back end, the rear air exhaust assembly comprising at least one of a plurality of exhaust air holes or a rear air exhaust port;
flowing the water through a water line tube in a body and flowing the air through an air intake tube in the body, the air intake tube connecting to the exterior port of air, the water line tube connecting to the exterior port of water;
powering a dental spindle using the air received at a head, the head at a distal end, the head comprising an air intake port and an air return exhaust port, the air intake port driving the dental spindle using the air, and the air return exhaust port returning the air back through the body and to the rear air exhaust assembly;
blocking air leakage from the head; and
expelling the air out the back end of the device using the rear air exhaust assembly.

17. The method of claim 16, wherein the rear air exhaust port of the rear air exhaust assembly exhausts the air from the body after the air powers a turbine that drives the dental spindle.

18. The method of claim 16, wherein the plurality of exhaust air holes of the rear air exhaust assembly exhaust the air from the body after the air powers a turbine that drives the dental spindle.

19. The method of claim 16, wherein the head further comprises a plurality of seals to block air leakage from the head.
